(19) United States
(12) Patent Application Publication
(10) Pub. No.: US 2019/0077307 A1
(43) Pub. Date: Mar. 14, 2019

(54) CUSTOMIZATION OF A ROAD MARKING FUNCTION

(71) Applicant: Valeo Vision, Bobigny Cedex (FR)

(72) Inventor: David Hue, Bobigny Cedex (FR)

(73) Assignee: Valeo Vision, Bobigny Cedex (FR)

(21) Appl. No.: 16/128,925

(22) Filed: Sep. 12, 2018

(30) Foreign Application Priority Data
Sep. 12, 2017 (FR) 1758407

(51) Int. Cl. B60Q 1/24; B60Q 1/52; B60K 35/00

(52) U.S. Cl. CPC B60Q 1/245; B60Q 1/525; B60K 2350/1084; B60K 2350/1004; B60K 35/00

(57) ABSTRACT

A method for customizing at least one parameter of a road marking function of a lighting system of a motor vehicle, the method including the following steps: driving the lighting system on the basis of an initial value of at least one parameter of a road marking function; displaying a graphical interface for controlling the parameter of the road marking function; upon reception of a command to modify the parameter, adjusting the driving of the road marking function in real time on the basis of the modification command.

The present invention relates to the field of driving assistance, in particular driving assistance for a motor vehicle, in particular via a road marking function of a lighting system of the motor vehicle. It targets in particular the customization of parameters of such a function.

It is applicable in the control of lighting systems, such as motor vehicle headlight devices in lighting and/or signalling applications. Such a lighting system may incorporate headlights, or headlamps, of the motor vehicle, so as to illuminate the road in front of the vehicle, at night or under low light conditions, by means of a light beam.

To assist in the driving of the motor vehicle, it is known to produce a road marking via a function of the lighting system of the motor vehicle. The road marking may be produced by introducing dark zones into the light beam of the lighting system, the dark zones being around or on either side of the marking to be produced, the user thus viewing the marking through contrast between shaded zones and lit zones.

The marking functions may also be performed at the rear of the motor vehicle for the purpose of signalling for the motor vehicles behind the motor vehicle of the user.

According to the solutions of the prior art, the marking functions are preset. However, each driver has completely different driving preferences, preferences relating to the marking and/or visual capabilities, and so it would be preferable to be able to customize such marking functions.

The present invention improves the situation.

A first aspect of the invention relates to a method for customizing at least one parameter of a road marking function of a lighting system of a motor vehicle, the method comprising the following steps:

driving the lighting system on the basis of an initial value of at least one parameter of a road marking function;

displaying a graphical interface for controlling the parameter of the road marking function;

upon reception of a command to modify the parameter, via the graphical interface for example, real-time adjustment of the driving of the road marking function on the basis of the modification command.

‘Road marking’ is understood to mean any traffic signal marked on a road. For example, a marking may correspond to a longitudinal mark such as an unbroken or broken guiding line, delineating the road for the purpose of guiding traffic.

‘Real-time adjustment’ is understood to mean modifying the driving of the lighting system by varying the parameter of the road marking function, during the reception of the modification command. Such a modification command may be gradual or non-instantaneous, for example in the case that a user moves a cursor over a graphical interface. As a variant, the modification command may be incremental, so as to modify the parameter of the initial value to a different value.

Such a real-time adjustment advantageously allows a user to customize the road marking function with high accuracy, since he has immediate feedback as to the modification that he is making to the parameter of the road marking function.

According to one embodiment, the method may furthermore comprise, following the reception of the modification command, a step of confirming the modification command via the graphical interface.

This embodiment makes it possible to avoid a user making a modification command input error via the graphical interface.

In addition, the method may furthermore comprise, following the confirmation of the modification command, a step of storing the parameter modified on the basis of the modification command.

This embodiment advantageously makes it possible to avoid repeating the customization upon each activation of the lighting system or of the road marking function.

In one embodiment, the method may furthermore comprise a step of selecting, via the graphical interface, the road marking function from among a plurality of road marking functions.

It is thus made possible to customize a plurality of road marking functions via the same graphical interface.

In addition, the method may furthermore comprise, following the selection of the road marking function, displaying the parameter or the parameters of the selected road marking function.

According to one embodiment, the method may furthermore comprise a step of downloading an additional parameter of the road marking function, the additional parameter being able to be controlled by the graphical interface that is displayed.

It is thus possible to enrich the customization of the road marking function, by taking advantage of the possibilities for the motor vehicle to access a data network, such as a mobile telecommunications network.

According to one embodiment, the modification command may comprise moving a cursor over the graphical interface, the driving of the road marking function being adjusted during the movement of the cursor over the graphical interface.

Customization by a user is thus facilitated, the driving of the lighting system being adjusted in real time during the movement of the cursor.

According to one embodiment, the road marking function may be a road line marking function and may comprise at least one from among the following parameters:
a distance between the motor vehicle and a line beginning;
a line length;
a line width;
an incline between the two lines, when two lines are marked on the road;
a line type; and
a line image.

This embodiment makes it possible to assist in the driving of the vehicle, customize this assistance on the basis of the driver and improve safety, in particular in the event of reduced visibility.

According to one embodiment, the road marking function is a GPS assistance function comprising a road marking including an arrow, the GPS assistance function comprising at least one from among the following parameters:
an arrow type;
a distance between the arrow and the motor vehicle;
a lateral position of the arrow; and
an incline of the arrow.

Such an embodiment makes it possible to improve the driving of the vehicle by the user and the associated safety, in that the user is able to remain concentrated on the road when consulting direction indications.

According to one embodiment, the road marking function may be an anti-collision function and may comprise at least one from among the following parameters:
an inter-vehicle time;
when the road marking is created in the form of a horizontal bar, a length of the horizontal bar; and
a width of the horizontal bar.

Such an embodiment makes it possible to improve the safety associated with the driving of the vehicle.

A second aspect relates to a computer program including instructions for implementing the steps of the method according to the first aspect of the invention when these instructions are executed by a processor.

A third aspect relates to a medium for storing a computer program including instructions for implementing the steps of the method according to the first aspect of the invention when these instructions are executed by a processor.

A fourth aspect of the invention relates to a device for driving a lighting system of a motor vehicle, the device comprising a processor configured to:

drive the lighting system on the basis of an initial value of at least one parameter of a road marking function;

communicate with a graphical interface for controlling the parameter of the road marking function via an interface;

upon reception of a command to modify the parameter via the interface, adjust the driving of the road marking function in real time on the basis of the modification command.

A fifth aspect of the invention relates to a motor vehicle comprising a lighting system and a device for driving the lighting system according to the fourth aspect of the invention.

Other features and advantages of the invention will emerge upon examining the following detailed description and the appended drawings, in which:

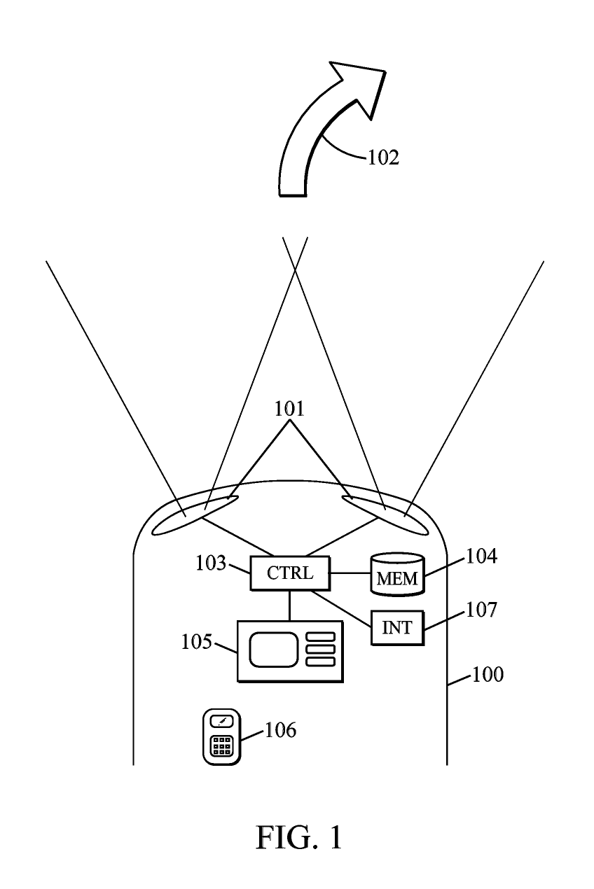

FIG. 1 illustrates a system for customizing a road marking function of a motor vehicle lighting system, according to one embodiment of the invention;

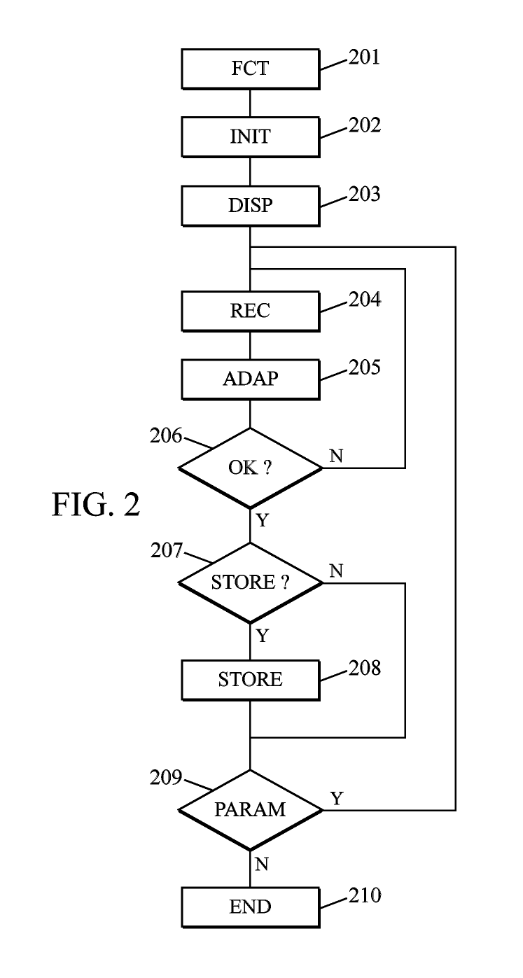

FIG. 2 is a diagram illustrating the steps of a method according to one embodiment of the invention;

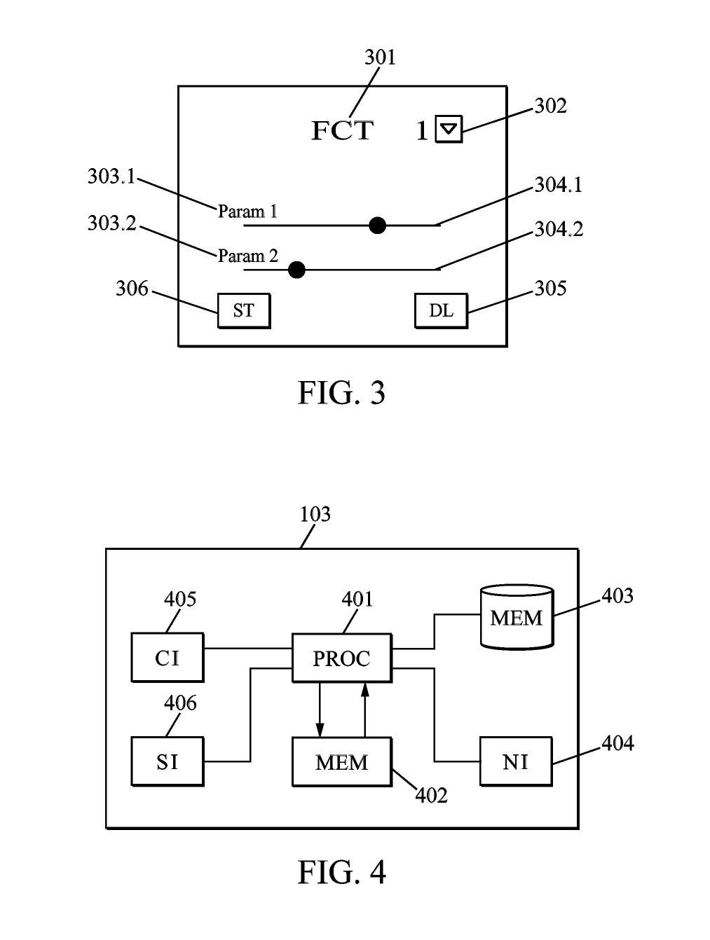

FIG. 3 shows a graphical interface for controlling a parameter of a road marking function according to one embodiment of the invention;

FIG. 4 shows a detailed illustration of a driving device according to one embodiment of the invention.

FIG. 1 illustrates a motor vehicle 100 configured to customize parameters of a road marking function of a lighting system 101 of the motor vehicle 100, according to one embodiment of the invention. As indicated above, the lighting system may incorporate headlights, such as front headlamps, such as shown illustratively and without restriction in FIG. 1. Specifically, the lighting system performing the marking function may comprise, as an alternative or in addition, rear headlamps of the motor vehicle 100.

To perform the road marking function, the lighting system may be a picture beam digital micromirror device, or picture beam DMD, system, which is well known and will not be outlined further in the present description. However, the lighting system 101 according to the invention covers any lighting system capable of performing a road marking function.

The motor vehicle 100 comprises a driving device 103 configured to drive the lighting system, in particular to drive the road marking functions of the lighting system. To this end, the driving device 103 may dynamically vary parameters of the marking functions, which parameters will be described in detail later on.

The driving device 103 may comprise a processor configured to implement the steps of the method that will be described later on with reference to FIG. 2.

The driving device 103 may be linked to a memory 104 forming a storage space, so as to store for example parameters defined by one or more users, as will be better understood upon reading the following text.

The driving device 103 may furthermore be linked to a network interface 107, such as a wireless network interface able to access a wireless data network, such as a 3G, 4G or later generation mobile data telecommunications network.

Furthermore, the driving device 103 is able to communicate with a graphical interface dedicated to controlling a parameter of a road marking function. The graphical interface will be described further with reference to FIG. 3.

According to a first embodiment, the graphical interface is displayed by an on-board computer 105 of the motor vehicle. According to this first embodiment, all of the elements of the system are therefore incorporated into the motor vehicle 100, which is thus able to store, in the memory 104, an item of software dedicated to customizing road marking function parameters. As a variant, the dedicated item of software may have been downloaded from the network interface 107 and stored in the memory 104.

In the first embodiment, the user of the motor vehicle 100 may vary the parameters of a road marking function directly via the graphical interface of the on-board computer 105. To allow user inputs, the on-board computer may comprise a touchscreen, or alternatively a set of buttons or a keyboard. A command, input by the user on the on-board computer 105, to modify a parameter may be transmitted directly to the driving device 103 by a wired interface for example.

According to a second embodiment, the graphical interface is displayed on a mobile terminal 106 of the user, such as a mobile telephone of smartphone type, a touchscreen tablet or a portable computer for example.

The graphical interface may be generated by an application dedicated to customizing the parameters of road marking function(s), the application having for example been downloaded beforehand onto the mobile terminal 106.

In the second embodiment, a command, input by the user, to modify a parameter may be transmitted to the driving device 103. To this end, the mobile terminal 106 may access, via the dedicated application, the driving device 103 via the mobile data telecommunications network. As a variant, a local area network of Wi-Fi type may be created by the driving device 103, and the terminal 106 may thus communicate with the driving device 103 via the local area network.

For the sake of illustration, a road marking 102 of ‘arrow’ type has been shown in FIG. 1. However, the invention is in no way restricted to road markings in the form of images giving direction indications, which road marking function is called a GPS (for global positioning system) information function. Specifically, as a variant, the road marking may create unbroken or dashed lines on the edge and/or in the middle of the road, or curved lines to mark a bend. Such a function is called a line marking function. As a variant, a road marking function may create a bar representing an inter-distance time with a vehicle in front. Such a function is called a front anti-collision function. There is thus no restriction attached to the type of road marking projected by the lighting system 101.

As a variant, when the road marking is produced by rear headlamps of the vehicle, it may show a bar representing an inter-distance time with the vehicle behind, a pictogram indicating a hazard, a curved line indicating a bend, etc.

FIG. 2 is a diagram illustrating the steps of a customization method according to one embodiment of the invention.

In a step 201, a road marking function may be selected, for example automatically following starting of the motor vehicle 100 or following activation of a touch button or mechanical button by the user of the motor vehicle. The marking function may be selected from among a plurality of marking functions that may be performed by the lighting system 101, such as the GPS information, front anti-collision, line marking and other functions.

In a step 202, the driving device 103 drives the lighting system 101 on the basis of an initial value of at least one parameter of the road marking function. If the road marking function is associated with a plurality of parameters, an initial value is obtained by the driving device 103 for each of the parameters of the road marking function. The initial values may be stored in the memory 104 and may be preset, for example by the manufacturer of the motor vehicle. As a variant, the initial values may have been downloaded via the network interface 107.

In a step 203, a graphical interface is displayed on the mobile terminal 106 or on the on-board computer 105, depending on the embodiment under consideration, the graphical interface allowing at least one parameter of the road marking function selected in step 201 to be controlled. The displaying may be controlled by the driving device 103 or by a remote server associated with the graphical interface, or may be implemented autonomously by the graphical interface.

In a step 204, a command to modify the parameter is received via the graphical interface and transferred in real time to the driving device 103.

In a step 205, the driving device 103 adjusts the driving of the road marking function in real time on the basis of the modification command.

There is no restriction attached to the modification command. For example, the modification command may consist in the user inputting a numerical value. Upon inputting of this value, the driving device 103 drives the lighting system 101 so as to change the parameter from its initial value to the numerical value input by the user. As a variant, the modification command may consist in gradually varying a cursor, and the driving device 103 thus varies the value of the parameter for the lighting system 101 in real time, on the basis of the position of the cursor.

Thus, customization or parameterization by the user is facilitated by the adjustment of the driving of the road marking function in real time, in that the user has immediate feedback as to his manipulation of the graphical interface.

For example, if the parameter of the marking function is a contrast level, and the user varies the contrast level via the graphical interface from the initial value k0 to a higher value k1, the driving device 103 adjusts the contrast level of the road marking projected by the system in real time, such that the contrast of the road marking varies between k0 and k1.

There is no restriction attached to the parameters under consideration. Hereinafter, parameters of the road marking functions outlined above are given solely by way of illustration.

In the example of a road marking function of line marking type, the parameters of the function may comprise at least one from among:
a distance between the motor vehicle 100 and a line beginning. Line beginning is the name given to that part of the line that is closest to the motor vehicle 100;
a line length;
a line width;
an incline between the two lines, when two lines are marked on the road. Such an incline corresponds to a rotation applied to the lines for the purpose of making them converge. Not applying an incline results in two parallel lines being obtained. By contrast, a high-value incline corresponds to a rapid convergence of the lines at a short distance from the vehicle, for example 50 metres away. The rotation point of the lines is preferably taken to be the starting point of the line.
a line type. Line type is understood to mean that the line is an unbroken line or a dashed line for example;
a line image. Line image is understood to mean the appearance of the line, such as a pattern of the line or a colour of the line.

Such a function makes it possible to guide a driver of the motor vehicle 100 in difficult traffic situations, such as in fog for example.

In the example of a GPS information function, comprising in particular the arrow road marking, the parameters of the function may comprise at least one from among:
an arrow type, in particular comprising its shape;
a distance between the arrow and the motor vehicle 100;
the lateral position of the arrow, i.e. its position on the width of the road;
the incline of the arrow.

Such a function makes it possible to improve the driving of the driver without requiring him to consult a screen in the vehicle, thereby also improving safety.

In the example of an anti-collision function, the parameters of the function may comprise at least one from among:
an inter-vehicle time;
the length of the horizontal bar, when the road marking is created in the form of a horizontal bar;
the width of the horizontal bar.

Such a function makes it possible, as explained above, to inform the driver of the motor vehicle 100 of the inter-distance time with the vehicle in front.

Once the parameter has been adjusted, the graphical interface may request confirmation from the user to lock the modified parameter for driving the road marking function. The user's response is received and transferred to the driving device 103 in a step 206.

If the user does not confirm the modification of the parameter(s), the method returns to step 204 until the reception of a new modification command from the user.

If the user confirms the modification of the parameters, the graphical interface may or may not receive an instruction to store the modified parameters in a step 207.

If an instruction to store the modified parameters is received, the storage instruction is transmitted to the driving device 103, which stores the modified parameters in the memory 104 or on a remote server via the network interface 107 in a step 208.

In a step 209, the graphical interface invites the user to modify another or other parameters. To propose such a choice, the graphical interface may display a window asking the question ‘would you like to modify other parameters’ and displaying two buttons ‘yes’ and ‘no’, or may simply continue to display all of the parameters of the road marking function, as will be described in detail later on with reference to FIG. 3.

If the user wishes to modify other parameters, the method returns to step 204 until the reception of a new modification command.

In the opposite case, the method concludes with step 210. To this end, the graphical interface dedicated to customizing parameters may be replaced by a more general menu.

FIG. 3 shows a graphical interface for controlling parameters of the road marking function, according to one embodiment of the invention.

The graphical interface may indicate an identifier 301 of the road marking function. A button 302 may make it possible to show all of the road marking functions that are accessible according to the invention. For example, upon selecting the button 302, a scrolling menu may be displayed in a superimposed manner for selecting one of the functions.

Once the function has been selected, all or some of the parameters associated with the selected function are identified by identifiers 303.1 and 303.2. Two parameters are shown by way of illustration in FIG. 3. However, the invention applies to any number of parameters (greater than or equal to one).

In association with each identified parameter, the graphical interface may display a means for the user to enter a modification command. Such a means may be respective cursors 304.1 and 304.2 that may vary between extreme values of the parameters with which they are associated.

The user may gradually or incrementally vary the cursors 304.1 and 304.2 between the initial value and the final value, that is to say the one that the user ultimately chooses. To improve the accuracy of the customization, and as described in detail above, the driving device 103 drives the lighting system 101 in real time during the reception of the modification command.

Instead of the cursors 304.1 and 304.2, as an alternative, the graphical interface may display windows allowing the user to enter a numerical value directly, without moving the cursor.

In addition, the graphical interface may display a button 305 that forms a link to a remote server and that makes it possible to download one or more additional parameters of the selected function or an additional road marking function. If the graphical interface is displayed on the mobile terminal 106, the downloaded additional parameters or the additional function may be installed and stored in the mobile terminal 106 or in the memory 104 of the motor vehicle. If the graphical interface is displayed on the mobile terminal 106, the downloaded additional parameters or the additional function may be installed and stored in the memory 104 of the motor vehicle.

An optional button 306 may furthermore make it possible to activate the storage of the modified parameter(s) in accordance with step 208 described above.

For example, in the case of the GPS information function, new images may be downloaded, such as different arrow shapes.

FIG. 4 shows a driving device 103 according to one embodiment of the invention.

The driving device 103 comprises a random access memory 402 and a processor 401 for storing instructions that make it possible to implement the steps of the method described above. The driving device also optionally includes a memory 403 for storing data that are intended to be kept after the method has been applied. Thus, as an alternative, the data described above may be stored in the memory 403 or in the memory 104 of the motor vehicle illustrated with reference to FIG. 1. As an alternative, the memories 104 and 403 may be combined.

The driving device 103 furthermore includes a network interface 404 able to communicate with a mobile data communications network. The network interface 404 may be combined with the network interface 107 of the motor vehicle, or these entities may be separate. The network interface 404 allows access to remote servers, makes it possible to control the graphical interface on the mobile terminal 106 via such a remote server, and makes it possible to download road marking functions and/or additional road marking function parameters.

The driving device 103 may furthermore comprise a driving interface 406 linked to the lighting system of the motor vehicle, and an interface 405 for commanding the graphical interface of the on-board computer 105.

Of course, the invention is not limited to the embodiments described above and provided solely by way of example. It encompasses numerous modifications, alternative forms and other variants able to be contemplated by those skilled in the art within the context of the present invention, and in particular any combination of the various embodiments described above.

1: Method for customizing at least one parameter of a road marking function of a lighting system of a motor vehicle, the method comprising the following steps:
driving the lighting system on the basis of an initial value of at least one parameter of a road marking function;
displaying a graphical interface for controlling the parameter of the road marking function;
upon reception of a command to modify the parameter, real-time adjustment of the driving of the road marking function on the basis of the modification command.

2: Method according to claim 1, furthermore comprising, following the reception of the modification command, a step of confirming the modification command via the graphical interface.

3: Method according to claim 2, furthermore comprising, following the confirmation of the modification command, a step of storing the parameter modified on the basis of the modification command.

4: Method according to claim 1, furthermore comprising a step of selecting, via the graphical interface, the road marking function from among a plurality of road marking functions.

5: Method according to claim 4, furthermore comprising, following the selection of the road marking function, displaying the parameter or the parameters of the selected road marking function.

6: Method according to claim 1, furthermore comprising a step of downloading an additional parameter of the road marking function, the additional parameter being able to be controlled by the graphical interface that is displayed.

7: Method according to claim 1, wherein the modification command comprises moving a cursor over the graphical interface, the driving of the road marking function being adjusted during the movement of the cursor over the graphical interface.

8: Method according to claim 1, wherein the road marking function is a road line marking function and comprises at least one from among the following parameters:
a distance between the motor vehicle and a line beginning;
a line length;
a line width;
an incline between the two lines, when two lines are marked on the road;
a line type; and
a line image.

9: Method according to claim 1, wherein the road marking function is a GPS assistance function comprising a road marking including an arrow, the GPS assistance function comprising at least one from among the following parameters:
an arrow type;
a distance between the arrow and the motor vehicle;
a lateral position of the arrow; and
an incline of the arrow.

10: Method according to claim 1, wherein the road marking function is an anti-collision function and comprises at least one from among the following parameters:
an inter-vehicle time;
when the road marking is created in the form of a horizontal bar, a length of the horizontal bar; and
a width of the horizontal bar.

11: Computer program including instructions for implementing the steps of the method according to claim 1 when these instructions are executed by a processor.

12: Medium for storing a computer program including instructions for implementing the steps of the method according to claim 1 when these instructions are executed by a processor.

13: Device for driving a lighting system of a motor vehicle, the device comprising a processor configured to:
drive the lighting system on the basis of an initial value of at least one parameter of a road marking function;
communicate with a graphical interface for controlling the parameter of the road marking function via an interface;
upon reception of a command to modify the parameter via the interface, adjust the driving of the road marking function in real time on the basis of the modification command.

14: Motor vehicle comprising a lighting system and a device for driving the lighting system according to claim 13.

15: Method according to claim 2, furthermore comprising a step of selecting, via the graphical interface, the road marking function from among a plurality of road marking functions.

16: Method according to claim 2, furthermore comprising a step of downloading an additional parameter of the road marking function, the additional parameter being able to be controlled by the graphical interface that is displayed.

17: Method according to claim 2, wherein the modification command comprises moving a cursor over the graphical interface, the driving of the road marking function being adjusted during the movement of the cursor over the graphical interface.

18: Method according to claim 2, wherein the road marking function is a road line marking function and comprises at least one from among the following parameters:
a distance between the motor vehicle and a line beginning;
a line length;
a line width;
an incline between the two lines, when two lines are marked on the road;
a line type; and
a line image.

19: Method according to claim 2, wherein the road marking function is a GPS assistance function comprising a road marking including an arrow, the GPS assistance function comprising at least one from among the following parameters:
an arrow type;
a distance between the arrow and the motor vehicle;
a lateral position of the arrow; and
an incline of the arrow.

20: Method according to claim 2, wherein the road marking function is an anti-collision function and comprises at least one from among the following parameters:
an inter-vehicle time;
when the road marking is created in the form of a horizontal bar, a length of the horizontal bar; and
a width of the horizontal bar.
